(19) United States
(12) Patent Application Publication
(10) Pub. No.: US 2025/0366490 A1
(43) Pub. Date: Dec. 4, 2025

(54) CONFECTIONERY PRODUCT RESISTANT TO HIGH TEMPERATURES

(71) Applicant: Perfetti Van Melle S.P.A., Lainate (Milano) (IT)

(72) Inventors: Consiglia Vitale, Legnano (MI) (IT); Claudia Capelletti, Lainate (Milano) (IT)

(73) Assignee: Perfetti Van Melle S.P.A., Lainate (Milano) (IT)

(21) Appl. No.: 18/863,428

(22) PCT Filed: May 9, 2023
(86) PCT No.: PCT/IB2023/054777

§ 371 Date: Nov. 6, 2024

(30) Foreign Application Priority Data
May 9, 2022 (IT) 102022000009458

(51) Int. Cl. A23G 3/42; A23G 3/44

(52) U.S. Cl. CPC A23G 3/42; A23G 3/44

(57) ABSTRACT

Disclosed is a confectionery product containing sugar and a gelatin base, able to withstand high temperatures and improper sale conditions, such as exposure to particularly high temperatures without adequate protection.

### FIELD OF INVENTION

Disclosed is a confectionery product containing sugar and a gelatin base, able to resist to high temperatures and improper sale conditions, such as exposure to particularly high temperatures without adequate protection.

### PRIOR ART

Conventional confectionery products containing sugar and having a gelatin base, also known as gumdrops or jellies, if exposed to a temperate climate, maintain their characteristics and reach the consumer in excellent condition; however, when they are exposed to high temperatures, such as those present in geographical areas characterised by particularly hot and/or humid climates, they undergo changes in appearance and texture, due to melting and deliquescence, which adversely affect their shelf life, namely the period for which a product remains suitable for consumption, and the acceptability of the product to consumers

Confectionery products based on starch and based on gum arabic are known to withstand heat and humidity better than those containing gelatin, but do not exhibit the same organoleptic characteristics, especially the elasticity perceived at the time of chewing. The same problem is also found in products based on pectin alone.

Carrageenan and gellan gum possess a high level of resistance to high temperatures, but present the drawback of not being usable in products with an acid or fruit base, because said ingredients would destroy their gel structure.

Confectionery products containing a gelatin/pectin/starch combination together with a variety of possible sweeteners, which are alternatives to one another, are described in EP 2600734 B1, filed by the Patentee. Said patent does not address the technical problem of stability of confectionery products with a gelatin base exposed to high temperatures.

Said technical problem is addressed by US20110071119, which describes edible, heat-resistant compositions comprising gelling agents, sweeteners and active ingredients. The gelling agent can be starch or carrageenan and any combination of said two ingredients with starch or pectin or gelatin.

The presence of the latter ingredients is expressly described as an alternative (“Depending on the binding agent used, the gelling compound may include, for example only, one of the following formulations”). Moreover, the sweetener in question is not limited to a specific type, but can alternatively be either a sugar or a syrup.

ES2236768T3 (EP890358) describes a process for the preparation of a chewable candy, which behaves like a chewing gum for at least one minute's chewing, and is then dissolved by the saliva for swallowing. The chewable candy comprises glucose syrup, but not combined with gelatin, pectin, sorbitol or starch.

### DESCRIPTION OF THE INVENTION

It has now been discovered that the problem of resistance to high temperatures presented by gelatin-based confectionery products containing sugar is effectively solved by combining a glucose syrup characterised by specific dextrose equivalent (DE) values, in particular 42 DE or 60 DE glucose syrup, with a gelling mixture consisting of pectin, gelatin and starch. Dextrose equivalent value is a measurement of the amount of reducing sugars present in a carbohydrate, expressed as a percentage on a dry basis relative to glucose.

The object of the invention is therefore a sugar-based chewable composition comprising a combination of starch, pectin and gelatin as gelling agent, and 42 or 60 DE glucose syrup.

The pectin is present in an amount ranging between 0.1% and 0.5% of the total weight of the composition, preferably between 0.3% and 0.5%; the gelatin is present in an amount lower than 6%, preferably between 3 and 6%, and the starch is present in an amount ranging between 3.5 and 20%, preferably between 5 and 10%.

The gelatin is preferably high bloom (250-300) gelatin, in a percentage generally ranging from 3% to 6%, and specifically from 3% to 5%, of the total weight of the composition in the case of aerated products, and 5% to 6% of the total weight of the composition in the case of non-aerated products.

The starch is preferably potato or corn starch or modified starch, preferably starch modified by treatment with acids.

The glucose syrup is present in an amount ranging from 20% to 30% of the total weight of the composition.

42 DE glucose syrup is particularly suitable for making expanded gelatins, whereas 60 DE glucose syrup can conveniently be used to make non-expanded gelatins.

In one of the preferred compositions, sorbitol is used to keep the crystallisation of the product below 3% and preserve the softness of the product throughout its storage period. The sorbitol is preferably present in a percentage ranging between 0.1% and 5% of the total weight of the composition, and even more preferably between 1% and 4% of the total weight of the composition.

In addition to the above-mentioned ingredients, water is added, which remains in the gumdrop intended for sale in a percentage ranging from 15% to 17% of the total weight of the composition in the case of expanded gelatins, and 17% to 19% of the total weight of the composition in the case of non-expanded gelatins.

The compositions according to the invention can also contain flavourings, colourings, flavour enhancers and other ingredients conventionally used to prepare confectionery products.

The compositions according to the invention can be aerated, i.e. swollen according to the prior art, by mechanical means or blowing in air, carbon dioxide, nitrogen or other gases. The result is a structure containing a myriad of microbubbles, surrounded by confectionery material.

The invention is illustrated in the examples.

### EXAMPLE 1

| | % |
|---|---|
| Glucose Syrup 42DE | 30.00 |
| Sugar | 40.00 |
| Starch | 6.00 |
| Gelatin 250 bloom | 4.00 |
| Pectin | 0.40 |
| Strawberry juice concentrate | 0.09 |
| Strawberry flavouring | 0.20 |
| Lactic acid | 0.30 |
| Allura Red | 0.01 |
| Citric acid | 1.00 |
| Sorbitol | 3.00 |
| Humidity | 15.00 |
| Total | 100.00 |

### EXAMPLE 2

| Ingredients | % |
|---|---|
| Glucose Syrup 60DE | 25 |
| Sugar | 45 |
| Starch | 5 |
| Gelatin 300 bloom | 5.3 |
| Pectin | 0.2 |
| Strawberry juice concentrate | 0.1 |
| Strawberry-cream flavouring | |
| Allura Red | 0.01 |
| Citric acid | 1 |
| Glazing agent | 0.2 |
| Moisture | 18 |
| Total | 100.00 |

### EXAMPLE 3

| Ingredients | % |
|---|---|
| Glucose Syrup 60DE | 20 |
| Sugar | 40 |
| Starch | 10 |
| Gelatin 300 bloom | 5 |
| Pectin | 0.1 |
| Orange flavouring | 0.19 |
| Carrot concentrate | 0.01 |
| Citric acid | 1.5 |
| Glazing agent | 0.2 |
| Sorbitol | 5 |
| Total | 100.00 |

1. A chewable sugar composition comprising a combination of starch, pectin and gelatin as gelling agent and 42 DE or 60 DE glucose syrup as sweetener.

2. The composition according to claim 1 wherein pectin is present in an amount ranging between 0.1% and 0.5% of the total weight of the composition.

3. The composition according to claim 1 wherein gelatin is present in an amount of less than 6% of the total weight of the composition.

4. The composition according to claim 3 wherein gelatin is present in an amount ranging between 3 and 6% of the total weight of the composition.

5. The composition according to claim 1, wherein starch is present in an amount ranging between 3.5 and 20% of the total weight of the composition.

6. The composition according to claim 5 wherein starch is present in an amount ranging between 5 and 10% of the total weight of the composition.

7. The composition according to claim 1, wherein the glucose syrup is present in an amount ranging between 20 and 30% of the total weight of the composition.

8. The composition according to claim 1, containing sorbitol as wetting agent in a percentage ranging between 0.1% and 5% of the total weight of the composition.
